(19) United States
(12) Patent Application Publication
(10) Pub. No.: US 2005/0222862 A1
(43) Pub. Date: Oct. 6, 2005

(54) System and method for designing custom jewelry and accessories

(76) Inventors: Kristen Guhde, San Francisco, CA (US); Renee Guhde, Clifton Park, NY (US)

Correspondence Address: Kristen Guhde, 1279 Waller St., San Francisco, CA, 94117, US

(21) Appl. No.: 11/093,925

(22) Filed: Mar. 29, 2005

Related U.S. Application Data
(60) Provisional application No. 60/557,507, filed on Mar. 30, 2004.

(51) Int. Cl. G06F 17/60

(52) U.S. Cl. 705/1; 705/26

(57) ABSTRACT

Systems and methods are set fort that enable users to design and purchase relatively complex and fashionable jewelry and accessories made to user specification. A pseudo random design process is described where the user can repeatedly create new designs that meet their design requirement and are relatively unique by simply pressing one button.

### CROSS-REFERENCE TO RELATED APPLICATIONS

The present Utility patent application claims priority benefit of the provisional application for patent No. 60/557,507 filed on Mar. 30, 2004 under 35 U.S.C. 119(e).

### FIELD OF THE INVENTION

The present invention relates generally to systems and methods for customized jewelry and accessories purchase. More particularly, the invention relates to systems and methods that enable users to design and purchase jewelry and accessories made to their specification.

### BACKGROUND OF THE INVENTION

Custom products have become increasingly popular over the past decade. The problem with most custom product applications is the amount of time the user must commit to designing a custom accessory. In addition to this time, the user must also have considerable design skills to create a custom product that meets their expectations.

When the user begins designing a custom accessory using the system outlined in the Hitachi patent, they are not given a template of an accessory to begin with, just a blank canvas containing parts. The user must know which parts are needed and have some knowledge of how the parts are placed. For example, when designing an accessory such as a necklace, the user must know that clasps must go on the end.

Although for necklaces this information is trivial, one could imagine a more complex accessory where all users would not know this type of information. In known methods, during the actual design process the user is not given a design to begin with, or a choice of designs to begin with, which requires them to have some knowledge and a high level of creativity be able to design an accessory that meets their expectations. Moreover, in existing applications, there is no way to cycle through an unlimited number of completely new and unique designs, or choose a design to then further customize.

Hence, there is a need to reduce these complexities by hiding of all of the details thereby allowing users to create more complex accessories by enabling the user to concentrate their time on choosing components to be places on the accessory, rather than concentrating on both choosing parts that comprise the basic design, and components that fashion the accessory.

Furthermore, in existing applications, there is no way to cycle through an unlimited number of completely new and unique designs, or choose a design to then further customize. There is furthermore a need to have this capability to spark the user's creativity, and push their creative edge, allowing them to design an accessory that will surpass their expectations.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates the general operating environment of an embodiment of the present invention;

FIG. 2b illustrates a flow chart of the accessory customization method according to an embodiment of the present invention. An example of a suitable GUI display is shown in FIG. 2a;

FIG. 3a shows a first embodiment of the pseudo-random template creation process proceeds according to the following steps;

FIG. 3b illustrates a second embodiment of the pseudo-random template generation module employs, instead, a pattern-matching method;

FIG. 4 illustrates a third embodiment of the pseudo-random template generation module where the user selects the components to use in the template;

FIG. 5 is a graphical representation of a necklace embodiment of the accessory template containing at least one segment 500 where components are placed;

FIG. 7 illustrates an example of the GUI implementing the design program according to an embodiment of the present invention which also interfaces the user with the customize design cycle method of the present invention;

FIG. 8 illustrates the architectural overview in accordance with an embodiment of the present invention; and

FIG. 9 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

Systems and methods are set fort that enable users to design and purchase relatively complex and fashionable jewelry and accessories made to user specification. Users may use the present invention to custom jewelry and accessories, including but not limited to necklaces, bracelets, earrings, purses, belts and shoes, which contain customizable components, such as beads, or pendants. In recent years, custom merchandise has become increasingly popular. The problem with most existing systems is the effort and time the creator must commit to designing a custom accessory. This system reduces that time while still allowing users to benefit from the uniqueness of the final product they receive without the headaches of making it themselves, and avoiding a complex, time consuming design process. In one aspect, the present system shortens the time it takes to create a relatively unique, customized accessory. In one embodiment, it accomplishes this aspect by using a pseudo random design process where the user can repeatedly create new designs that meet their design requirement that are relatively unique by simply pressing one button. The user can further customize these designs. The user can also choose a completely designed accessory to begin with and make a few changes to it to complete the customization process. By giving the user unique, complete designs to start with, the design process is simplified while still allowing the user to be creative and design a relatively unique product.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

The present invention is directed to a system and method that enable users to design and purchase jewelry and accessories made to their specification. In an aspect of the present approach, the need for the user to have existing knowledge of how the accessory is put together is largely eliminated. That is, at least the detailed steps of choosing parts that comprise a basic design and the components that fashion the accessory are hidden from the user. Another aspect of the present invention is to provide a way to cycle through an unlimited number of completely new and unique designs, and/or choose a design to then further customize, thereby freeing the user to spend his or her efforts on generating a creative along esthetic and practical considerations known to the art.

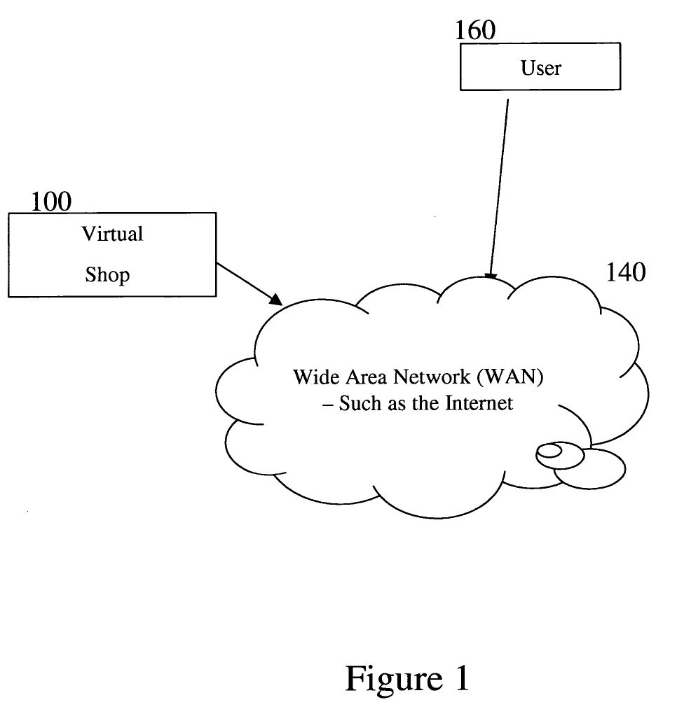

FIG. 1 illustrates the general operating environment of an embodiment of the present invention. In this embodiment, the computer program carrying out the present invention, and other parts of a virtual retail shop 100, are located on a server (not shown). The server is connected to a wide area network (WAN) 140, such as, By way of example, and not limitation, the Internet. A user 160 may access a GUI front end of virtual retail shop 100 through a service provider to wide area network 140 using infrastructure that is presently well known and available to the public. In alternative embodiments, other modes of accessing virtual retail shop 100 are implemented where, for example, user 160 directly accesses virtual retail shop 100 by interacting through a graphical user interface (GUI) using input and output devices that are directly connected to the server running the virtual retail shop without having to go through wide area network 140. It is contemplated that such embodiments may implement virtual retail shop 100 on stand-alone computers located in public, user 160 accessible locations such as, By way of example, and not limitation, a shopping malls or jewelry retail stores.

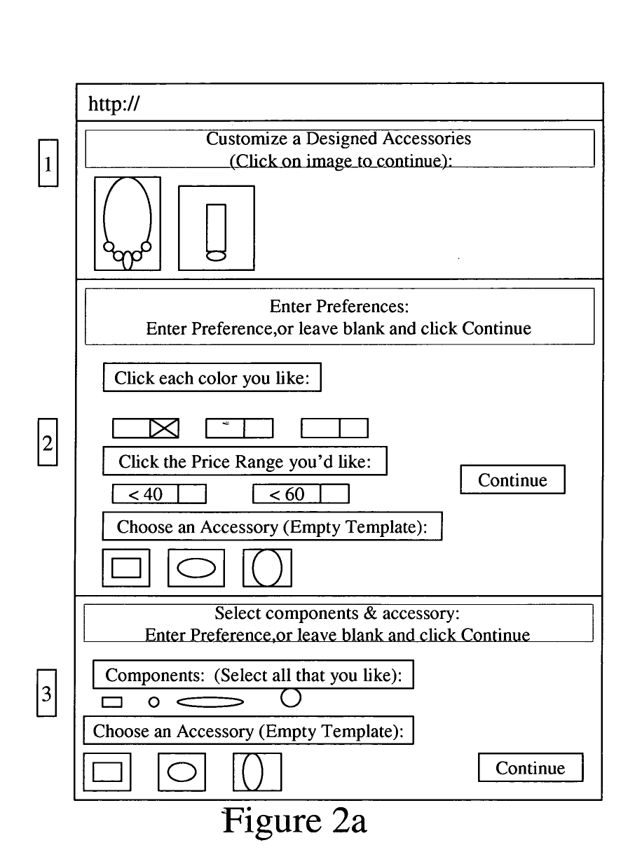

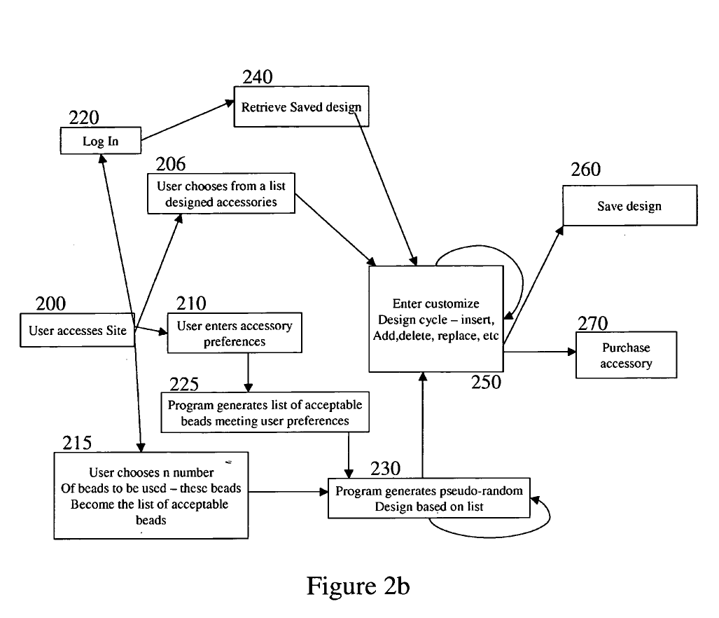

It should be appreciated that those in the art will readily be able to effectively implement the GUI, protocols, state machines, and databases that carry out the present invention as set forth herein. FIG. 2b illustrates a flow chart of the accessory customization method according to an embodiment of the present invention. In the Figure, a first step 200 is for the user to access the virtual retail shop program running on the server. For WAN networked access systems such as the internet, the user may access virtual retail shop 100 over the internet using commonly available web browser, which are capable of interacting with the virtual retail shop GUI using know software programming methods and platforms. In some embodiments, logging onto the virtual retail shop may be transparent to the user's connection means, which establishes a session with the virtual retail shop that runs the GUI. It is contemplated that some embodiments may instead require a standard secure and/or authenticated access session with the user.

After the user has properly access the virtual retail shop GUI, at least 4 template creation options are presented, they are to:
1. Choose an accessory that is completely designed (designed template) (Step 205);
2. Choose an empty template, and input user preferences (Step 210);
3. Choose an empty template, and input specific components to use in the template (Step 215); and
4. Retrieve a previously saved design (Step 220).
   Each of these branches leads to the creation or retrieval of an accessory template, which is loaded into a design program for customization (Step 250).

Following, initially, down Step 206, the user is presented with accessory design options that are based on already completely designed templates. A completely designed template is an accessory that is suitable to be purchased largely as is, requiring little if any modification. That is, it contains the proper number of components arranged in an appropriate and distinct ordering. When the user selects a pre-designed accessory template, the corresponding accessory is loaded into a design program, which enables the user to iteratively modify the template's existing components at Step 250. By way of example, and not limitation, considering a scenario where the user sees a designed template that is a necklace containing 30 beads in a certain order having one pendant in the center, and the user likes the 30 beads, but not the pendant. In this scenario, the user would load this designed template into the design program, and simply replace the pendant with a preferred component, or remove the pendant. In this way, the user has “customized” this accessory to his or her liking and it suitable to be later manufactured and purchase. For overall clarity, the design program is described in more detail after the present template creation options.

Referring again to FIG. 2b, an alternate option for the user to select from is to input user preferences to find suitable templates as indicated by Step 210. That is, if the user selects an empty template, the user also has the option to enter or select from a multiplicity of design parameters (or user preferences), such as, By way of example, and not limitation, color, price, style, etc. These design parameters are passed to the design program. A list of suitable design parameters that satisfy the design parameters is generated in Step 225. In some alternative embodiments, however, Step 225 will further filter the list of suitable design parameters based on certain predetermined considerations to select an optimal subset of the list, possible a single item, that is passed to the design program. Based on the list of suitable design parameters, the design program, in Step 230, then creates a relatively unique design for the user. In certain embodiments, when the user does not enter parameters to the design program, the program will alternate parameters from a predetermined set of design parameters that the creator of the design program supplies. However, if no design parameters are available, then the design program uses suitable default parameters known to provide acceptable results. By way of example, and not limitation, if the user inputs design parameters requiring attributes such a price under $50, and the colors white, purple and silver, the design program will create a new, relatively unique design based on these design parameters. Thus, the resulting accessory design comprises a set of components and an ordering thereof that satisfy the design parameters. Therefore, in the present embodiment, the items in list of suitable design parameters satisfy either the parameters supplied by the user or those default parameters predetermined by the system if the user provided no design parameters. A pseudo-random accessory template is generated at Step 230 based on the items in list of suitable design parameters created at Step 225. The pseudo-random accessory template will be described in more detail below, after the initial user options are described.

To support the user in more appropriately selecting the optimal design parameters from the list of suitable design parameters, in some embodiments, a suitable design display button is provided in the GUI that when activated by the user conveniently displays the various suitable designs corresponding to the items in the list. It is contemplated that displaying the various different designs in response to clicking the suitable design display button may be implemented according to known methods, such as, but not limited to, scrolling through each item or image of the list, or simultaneously displaying miniaturized images of all, or a subset, of the list on a page and paging through any additional pages by known means. In some embodiments of the present invention, once the user identifies a design they like, they are also provided with the option to further customize the accessory by changing components or attributes of the accessory, similar to Step 205.

Following now, the next of the present initial options presented to the user upon entry to the embodiment of FIG. 2b, Step 215 is similar to Step 210 except that instead of the user providing design parameters to the design program, the user directly selects specific components that the design program should use in creating new designs. These selected components are arranged into a list of acceptable components that is passed to the design program, which generates a pseudo-random accessory template at Step 230.

The last of the initial user options according to the present embodiment is Step 220 where the user logs into the computer system running the virtual retail shop 100 and, at Step 240, retrieves prior saved accessory template designs in progress to continue the customization process according to the present invention. The retrieved accessory template is functionally similar to any other designed accessory template that is generated in other steps or modules of the present invention. Once retrieved at Step 240, the user further modifies their retrieved accessory template at Step 250. Although not shown, other embodiments are contemplated where after Step 240 the user may branch to Step 225 or Step 215 whereby the design parameters of the saved design are automatically entered as the design parameters required for the respective step, and they proceed as described for each for the respective step. In alternative embodiments not shown, after Step 240 the user may branch directly to purchasing Step 270 or template saving Step 260.

As shown in the Figure, all of the foregoing initial user options flow into the customization design cycle of Step 250, which is also performed by the design program and described in more detail below. The design program, as previously characterized, creates accessory templates based on design parameters passed to it, and then enables the user to edit and customize the design parameters of the selected accessory template until the desired final product is completed. After customizing the accessory template, the user may, by way of known means, either save the accessory template as a work in progress at Step 260 and retrieve it later by way of Step 220 or purchase the accessory based on this customized accessory template at Step 270. If the user purchases the design, it is added to their shopping cart using available e-commerce means. They can continue shopping, or choose to checkout, and enter information to pay for the design. If the user saves the design, the program will store the design, and the user can return at any time in the future and continue designing the accessory via Step 240 or purchase it at Step 270. An example of the GUI display for Step 200 is shown in FIG. 2a.

Many alternative embodiments of the design program are contemplated that carry out the method taught by the present invention. In a first embodiment, the following steps and GUI elements are included:
1. A display showing the jewelry templates available to be customized
2. After the user selects the accessory they want to customize, it is loaded into a design window.
3. Users then enter the customize design cycle to customize their accessory by selecting an accessory template and iteratively modifying its components (e.g., replacing, deleting, or inserting components), and attributes (e.g., changing a segment's length)
4. Displaying the resulting arrangement

In a second embodiment of the design program, the user enters component preferences into the system (color, style, price, etc. . . .) and the Design Program creates one or more suitable pseudo-random templates based upon the user's preferences. This embodiment includes a “New Design” button, which the user can click an unlimited number of times until an acceptable design is found.

In the second embodiment, the following steps and GUI elements are included:
1. A display showing the accessory templates available to be modified
2. A display asking the user to input preferred design parameters (such as desired price range of the final accessory, or preferences of the individual components, such as color, cut, style, or a list of individual components)
3. The design program then generates an accessory template based on these design parameters and displays the resulting arrangement
   This accessory template can be further customized by the user by following steps 2-3 of the first embodiment, or the user can choose to have the program regenerate a design by going back to step 3 just above.

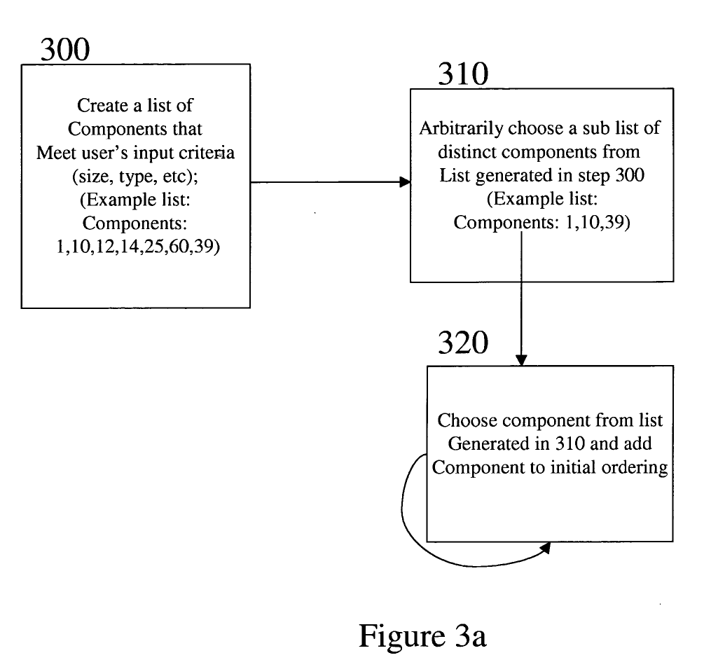

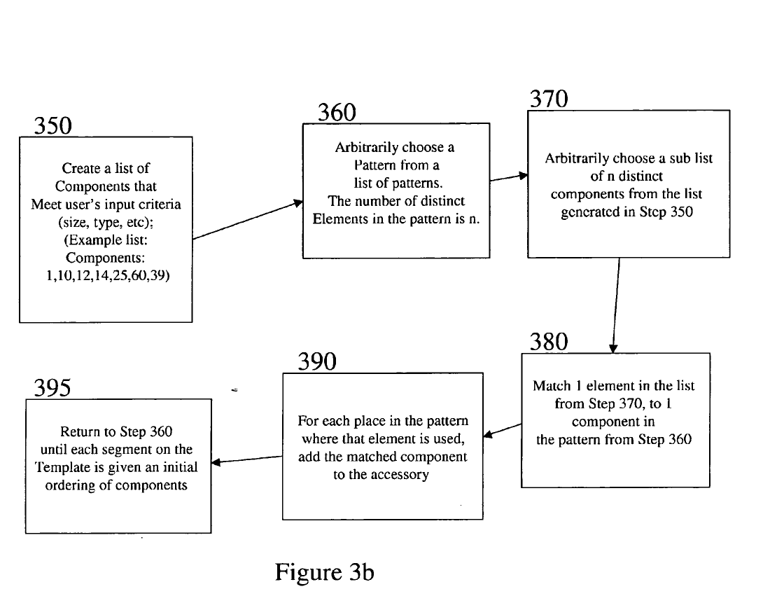

An embodiment of the present design program also includes a module that generates the pseudo-random accessory template. Some alternate embodiments of the present invention may implement known schemes and not include the pseudo-random accessory template generation module, and thereby would not include its attendant features and capabilities, but would still be capable of otherwise enabling the user to customize accessories according to the other principles of the present invention. A multiplicity of embodiments of the pseudo-random template generation module are contemplated. FIG. 3a shows a first embodiment of the pseudo-random template creation process proceeds according to the following steps:
1. Step 300: based on user's preferences, create a list of components that meet user's criteria
2. Step 310: arbitrarily choose a sub list of distinct components to use in the accessory from the list generated in step 300; i.e., choose some number ‘n’ of components, potentially of different types, from the list supplied by the user.
3. Step 320: create the initial ordering of components on each segment of the template chosen by the user by:
   a.-Arbitrarily choosing a component from the sub list of components generated in step 310, and add it to the initial ordering.
   b.Continue step 320 until each segment on the template is given an initial ordering of components.

FIG. 3b illustrates a second embodiment of the pseudo-random template generation module employs, instead, a pattern-matching method. The present embodiment of this module determines the ordering and the number of each component that the user specified for the design program to use. By way of example, and not limitation, if the user selects a six inch bracelet, and three distinct components, say a, b, and c, the design program would create six inch bracelets designs by suitably selecting, in accordance with known practical considerations, the number of each component to use and the ordering of all of the selected components, e.g., (a,b,b,b,b,b,b,a,c,c) or (a,a,a,a,b,b,b,c).

The algorithm for the present embodiment proceeds according to the following steps:
1. Step 350: based on user's defined design parameters, create a list of components that satisfies the user's criteria.

2. Step 360: Arbitrarily choose from a list of patterns. These patterns are like: c1, c2, c1, c1, c2, c3. Each pattern also has a number of distinct elements, n, that are contained in the list; e.g., the above example has 3 distinct elements.
3. Step 370: Arbitrarily choose a sub list of n distinct components from the list generated in Step 350.
4. Step 380: Match 1 element in the list from Step 370, to 1 component in the pattern from Step 360.
5. Step 390: For each place in the pattern where that element is used, add the matched component to the accessory.
6. Step 395: Return to Step 360 until each segment on the template is given an initial ordering of components.

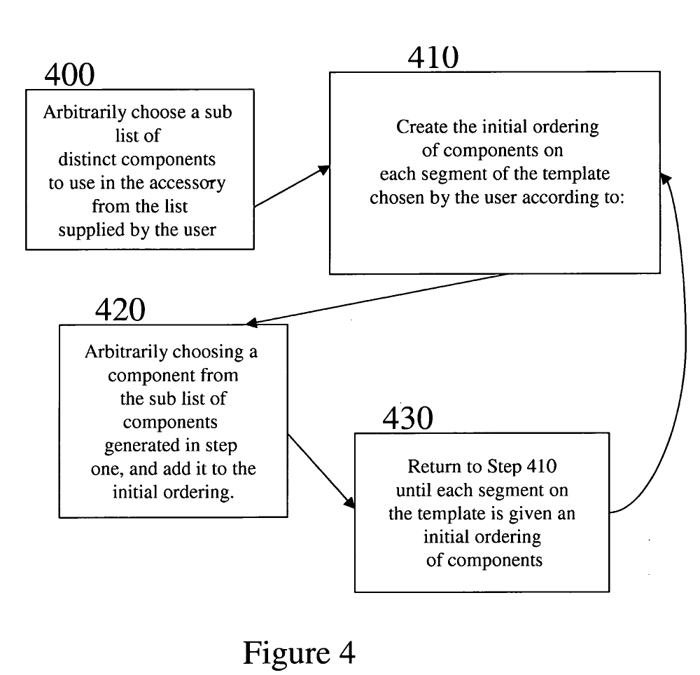

FIG. 4 illustrates a third embodiment of the pseudo-random template generation module where the user selects the components to use in the template. In this embodiment, the user selects the actual components that are used in the pseudo-random design algorithms mentioned in the second embodiment. The pseudo-random design process simply creates the initial ordering instead of generating a list of available components. The user selects the components to use, but does not specify the quantity of each component, or the ordering of each component. Each component the user specified can be used zero or any number of times, n, in the design. In the present embodiment, the pseudo-random template creation process comprises the following steps:
1. Step 400: arbitrarily choose a sub list of distinct components to use in the accessory; i.e., choose some number ‘n’ of components, potentially of different types, from the list supplied by the user.
2. Step 410: Create the initial ordering of components on each segment of the template chosen by the user according to:
   a. Step 420—Arbitrarily choosing a component from the sub list of components generated in step one, and add it to the initial ordering.
   b. Step 430—Return to Step 410 until each segment on the template is given an initial ordering of components.

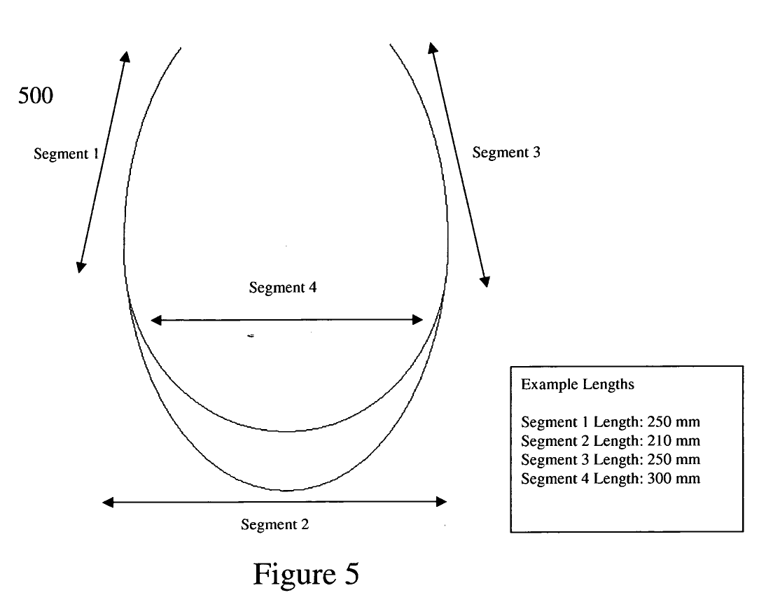

Embodiments of the aforementioned design template are presented in some detail in the following section. In the described embodiments, design templates are used to describe physical attributes of the accessory to be manufactured. FIG. 5 is a graphical representation of a necklace embodiment of the accessory template containing at least one segment 500 where components are placed. The design is personalized by allowing the user to control which components are placed on each segment as well as the ordering of the components on the segment. As shown in the Figure, an example of an ordering of the components that are placed on a segment is from left to right. Other orderings known to those in the art may be modeled by the design template as well. It should be appreciated that the virtual components displayed on the GUI and placed on a modeled segment substantially correspond to the physical accessory. Techniques to convert a virtual accessory model based on the present accessory template are well known to those in the art. By way of example, and not limitation, a virtually constructed necklace with accessory components along a line would be physically constructed by stringing the accessory components with a material such as a wire. Similarly, virtual accessories components for a belt, or the like, may be attached by known methods such as sewing or gluing the physical accessories components to the accessory.

A segment is simply the length attribute that controls the amount of space (lengthwise) that the user may add components. The type of accessory determines the method that the component is added to the each segment. The user does not control this functionality. Each segment contains an initial length, a maximum length and a minimum length. The user may change the length of each segment as long as the length falls in between the maximum and minimum lengths of the segment.

Each segment also comprises a set of properties that allow the GUI to appropriately draw the accessory be represented by way of known methods and applications. Typical properties modeled by the accessory template include the radius and angle of the segment, component alignment (e.g., align components left, center or right), and etc. Segment properties in the accessory template may also include maximum height or width or a component. Other advantageous and required parameters for virtually modeling a physical accessory are well known to the art an may be included in the accessory template as appropriate for the physical accessories being modeled in an application of the present invention. The accessory template also includes a multiplicity of design rules that depend on logistical and manufacturing considerations that are well known in the art. An example, include a constraint that a segment may not allow components over 30 mm to be added to it.

The GUI handles the geometry of actually drawing the segments in a 2-d or 3-d fashion. The GUI also handles user requests. It displays a list of which components are on each segment, and allows the user to interact with the components on each segment. By using the buttons in the design panel, or by dragging and dropping the components in the necklace, the user changes the ordering and/or position of the components in the accessory. The design program also is aware of each segments properties (such as maximum height), and will not allow the user to add a component that does not meet all of its properties.

In the present embodiment, when the GUI displays a design, each segment contains an initial ordering of components and an initial length in accordance with the above teachings. As described in some detail below, the user can modify this ordering in customize design cycle of the present invention, by deleting, replacing or adding (if length of segment permits) components to each segment, and also change the length of each segment.

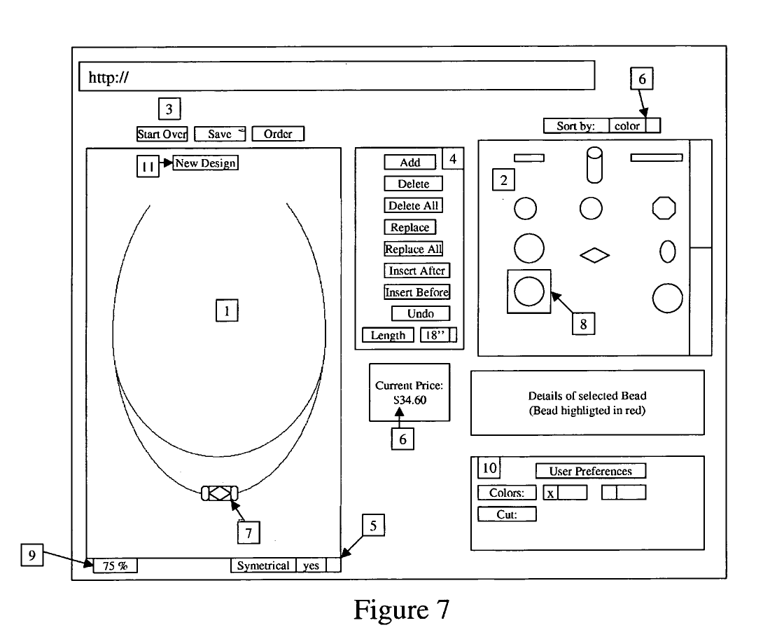

An embodiment of the customize design cycle indicated by Step 250 of FIG. 2b is described in further detail herein. FIG. 7 illustrates an example of the GUI implementing the design program according to an embodiment of the present invention which also interfaces the user with the customize design cycle method of the present invention.

An embodiment of the Design Program comprises the following elements, where each enumerated item numerically corresponds to the same numbered item in the Figure:

1. Accessory Display—The current state of the accessory template is displayed in 2-d or 3d display panel. The user can select each customizable component in the accessory display. When a component is selected, it is highlight (by, for example, shading or a box drawn around its boundaries) for the user.

2. Product Panel—This contains a scrollable list of components that can be used to customize the necklace:
a. The user can sort the components in the display box by choosing an attribute such as, for example, color, name, maker, price, size, or cut to sort the list.
b. As the user scrolls over the list, and clicks on an item, it becomes the user's selected component, and the component's attributes are shown in the box

3. Buttons Used to Save the design, Order the accessory, or Start Over with the Original design:
a. Save Button—This will save the current state of the accessory (the ordering of components, the template, and the templates' attributes). This information can later be used to reopen this design for the user.
b. Order—This button will save the current state of the accessory, and place the item in the user's shopping cart.
c. Start Over—This button will restore the original design that was loaded into the design program.

4. Buttons used to customize the design in the customize design cycle (see Step 250 of FIG. 2b). Once the user has retrieved a previously designed accessory template, or picked one of the random accessory templates generated from the pseudo random design process, the user then enters the customize design cycle. This is the process where the user further customizes the accessory template they have selected, which the user sees and modifies in Accessory Display 1. The user can use any of the following commands to modify the components of the accessory:
a. Add—Adds the selected component in the Product panel to the last position in the accessory.
b. Replace—Replaces the selected component in the accessory (8) with the selected component in the product panel (9).
c. Replace All—Replaces all components that are the identical to the component that is selected in the accessory with the component that is selected in the product panel.
d. Delete—Deletes the component that is selected in the accessory (8).
e. Delete All—Deletes all components that are identical to the component that is selected in the accessory (8).
f. Insert—Inserts the selected component in the product panel (9) after the selected component in the accessory (8).
g. Undo—Restores the state of the accessory before the last action.

5. Symmetrical Option—Either Yes or No, if Yes, the all actions the user makes are duplicated in lateral symmetry.

6. Sort By Option—A drop down menu allows users to sort the available components according to the defined properties—such as, for example, price, size, color, and cut.

7. Selected Accessory Item—When the user clicks on a component in the necklace, it is highlighted in red. Actions such as replace, insert and delete are operated on the selected item.

8. Selected Product Item—When the user clicks on a component in the product panel, it is highlighted in red. This component is used when buttons are pressed such as add, replace (replace component from Selected Accessory Item 8, with this component), etc.

9. View Percent—This drop down menu allows the user to change how large the design display area is.

10. User preference panel—This panel is where users have the option to submit different attributes that will be used in the pseudo-random design process.

11. New Design Button—This button will call the pseudo-random design program, and create a new design, replacing the previous design.

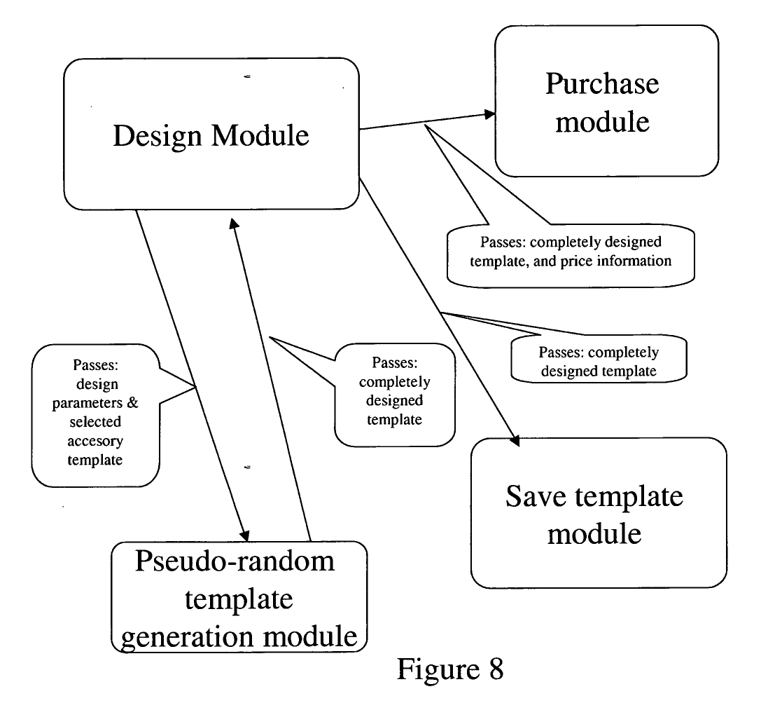

FIG. 8 illustrates the architectural overview in accordance with an embodiment of the present invention. In the Figure, selected modules are shown, which were described in some detail in the foregoing embodiments. The arrowed lines show the direction of information flow and connections between the modules. The information that these communication lines pass is characterized by the corresponding descriptions shown, in accordance with the teachings of the foregoing embodiments.

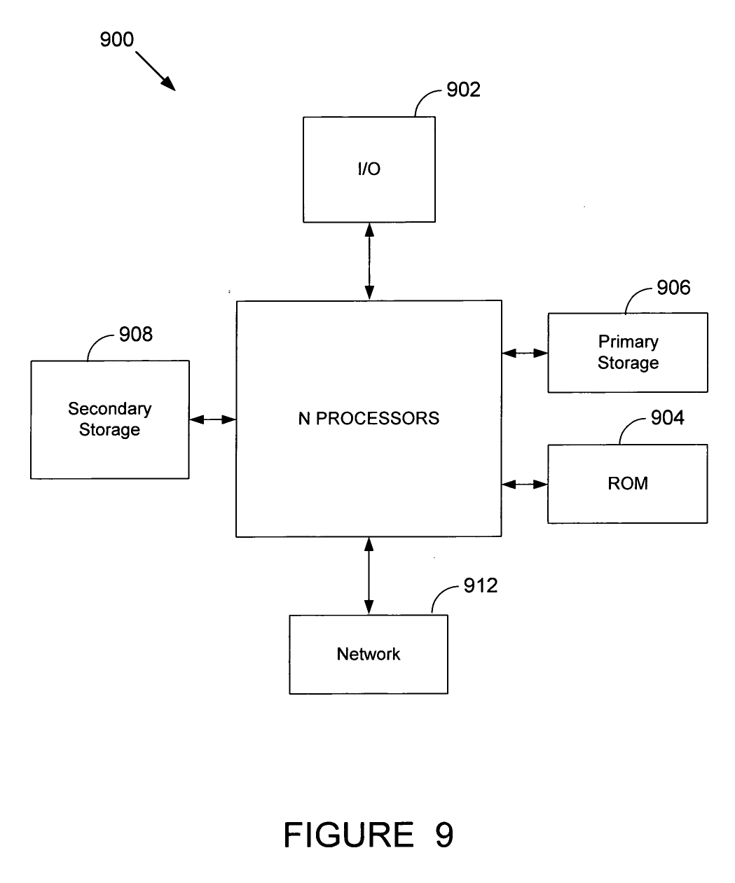

FIG. 9 illustrates a typical computer system that, when appropriately configured or designed, can serve as a computer system in which the invention may be embodied. The computer system 900 includes any number of processors 902 (also referred to as central processing units, or CPUs) that are coupled to storage devices including primary storage 906 (typically a random access memory, or RAM), primary storage 904 (typically a read only memory, or ROM). CPU 902 may be of various types including microcontrollers and microprocessors such as programmable devices (e.g., CPLDs and FPGAs) and unprogrammable devices such as gate array ASICs or general purpose microprocessors. As is well known in the art, primary storage 904 acts to transfer data and instructions uni-directionally to the CPU and primary storage 906 is used typically to transfer data and instructions in a bi-directional manner. Both of these primary storage devices may include any suitable computer-readable media such as those described above. A mass storage device 908 may also be coupled bi-directionally to CPU 902 and provides additional data storage capacity and may include any of the computer-readable media described above. Mass storage device 908 may be used to store programs, data and the like and is typically a secondary storage medium such as a hard disk. It will be appreciated that the information retained within the mass storage device 908, may, in appropriate cases, be incorporated in standard fashion as part of primary storage 906 as virtual memory. A specific mass storage device such as a CD-ROM 914 may also pass data uni-directionally to the CPU.

CPU 902 may also be coupled to an interface 910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications or internet network using an external connection as shown generally at 912. With such a connection, it is contemplated that the CPU might receive information from the network, or might output information to the network in the course of performing the method steps described herein.

Having fully described at least one embodiment of the present invention, other equivalent or alternative systems and methods of implementing electronic accessory design and purchase according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

1. A system for designing custom jewelry and accessories, the system comprising:
means for displaying available components for a jewelry or accessories design to a user;
means for prompting for and receiving user defined design parameters;
means for generating a list of acceptable components that correspond to the user defined design parameters; and
means for generating a plurality of designs based on said acceptable components list.

2. The system of claim 1, further comprising means for iteratively modifying a user selected design from said plurality of designs.

3. The system of claim 2, further comprising means for purchasing the design selected and finalized by the user.

4. A method for designing custom jewelry and accessories, the method comprising the Steps of:
displaying available components for a jewelry or accessories design to a user;
prompting for and receiving user defined design parameters;
generating a list of acceptable components; and
generating a plurality of designs based on a psuedo-randomly selected subset of said acceptable components list.

5. The method of claim 4, further comprising the Step of iteratively modifying a user selected design from said plurality of designs.

6. The method of claim 5, further comprising the Step of purchasing the design selected and finalized by the user.

7. The method of claim 4, wherein said Step of generating a list comprises the Step of the user selecting components to be included in said list.

8. The method of claim 7, wherein the Step of user component selection, the user does not specify the quantity of each component in the design.

9. The method of claim 7, wherein the Step of user component selection, the user does not specify the ordering of each component in the design.

10. The method of claim 4, wherein said Step of generating a list does not comprise the Step of the user selecting components to be included in said list.

11. The method of claim 7, wherein the Step of user component selection, the user specifies the quantity of each component in the design.

12. The method of claim 7, wherein the Step of user component selection, the user specifies the ordering of each component in the design.

13. The method of claim 4, wherein said Step of generating is automatically performed by a computer system.

14. The method of claim 4, wherein said user defined design parameters comprise color, name, maker, price, size, or cut parameters.

15. A computer program product for designing custom jewelry and accessories, the computer program product comprising:
computer code that displays available components for a jewelry or accessories design to a user;
computer code that prompts for and receives user defined design parameters;
computer code that generates a list of acceptable components that correspond to the user defined design parameters; and
computer code that generates a plurality of designs based on a psuedo-randomly selected subset of said acceptable components list; and
a computer-readable medium that stores the computer code.

16. The computer program product of claim 15, further comprising computer code that enables a user to iteratively modify the user's selected design from said plurality of designs.

17. The computer program product claim 16, further comprising computer code the enables the user to purchase the design selected and finalized by the user.

18. A computer program product according to claim 15 wherein the computer-readable medium is one selected from the group consisting of a data signal embodied in a carrier wave, a CD-ROM, a hard disk, a floppy disk, a tape drive, and semiconductor memory.

19. The computer program product of claim 15, wherein the computer code is distributed over a client/server environment and communicates to the distributed code modules over the Internet.
